(19) United States
(12) Patent Application Publication
(10) Pub. No.: US 2005/0270430 A1
(43) Pub. Date: Dec. 8, 2005

(54) Wireless projection system

(75) Inventors: Thomas Falck, Aachen (DE); Henning Maass, Aachen (DE); Klaus Weidenhaupt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/527,008

(22) PCT Filed: Aug. 27, 2003
(86) PCT No.: PCT/IB03/03843

§ 371 Date: Mar. 7, 2005

(30) Foreign Application Priority Data
Sep. 10, 2002 (DE) 102 42 161.7

(51) Int. Cl. H04N 9/31

(52) U.S. Cl. 348/744

(57) ABSTRACT

A method and a system for displaying images, and an image display apparatus for use thereof are described. An image display apparatus, for example, a projector (12) is controlled by a mobile apparatus, for example, a PDA (14) in such a way that the image display apparatus (12) generates images, preferably a presentation file, for example, in PowerPoint format and reproduces and displays the corresponding images. A representation of a displayed image is transmitted to the mobile apparatus (14) in which it is displayed.

The invention relates to a system and a method of displaying images, and to an image display apparatus for use in such a system.

Instead of sheets or slides used for presentations, presentations in the form of consecutive images are currently often generated and reproduced by means of a computer. For example, the PowerPoint program is known for this purpose, with which presentation files can be made and reproduced. The images are displayed, for example on a computer screen or on a computer-controlled projector.

Modern projectors already have the built-in capacity of reproducing presentations. In the data sheet “LCD Data Projector VPL-PX 15/PX 10/PS 10” of Sony, projectors are described which have a network connection and can read files presented in the network and reproduce them by means of their own reproduction program. These projectors also have a wireless interface so that they can be used in a wireless (ad hoc) network with mobile apparatuses (notebooks).

On this basis, the invention has for its object to propose a method and system for displaying images, as well as an image display apparatus in which the reproduction of a presentation on an image display apparatus can be carried out in a very comfortable way.

This object is solved by a system as defined in claim 1, an image display apparatus for use in this system as defined in claim 9 and by the method as defined in claim 10. Dependent claims are based on advantageous embodiments of the invention.

The constituents of the system according to the invention are an image display apparatus, on the one hand, and a mobile apparatus, on the other hand. The image display apparatus may be, for example, a display screen or another apparatus for displaying images. A projector for displaying an image on a remote projection face is preferably proposed. The image display apparatus comprises a display unit for displaying images and a reproduction unit for generating the images displayed by the display unit. The reproduction unit may reproduce, for example, presentations (for example, in PowerPoint format) in the form of files, in which the presentation is then displayed by the display unit.

According to the invention, a representation of an image displayed by the display unit is transmitted to the mobile apparatus in which it is displayed by a display unit.

The mobile apparatus is particularly characterized in that it is mobile, i.e. it can be held and easily handled by a user who holds, for example, a lecture supported by a presentation. As a mobile apparatus, it is neither cable-connected for the supply of energy nor for the transmission of data. The mobile apparatus has an interface for wireless data transmission, for example, by radio, infrared unit, etc. It is preferably a PDA (Personal Digital Assistant), i.e. a minicomputer with a display unit, a memory, a central unit and input means (for example, keys and/or touch screen). Alternatively, it may be, for example, an appropriate mobile telephone.

In the image display apparatus, a representation of the currently displayed image is created when displaying an image on the display unit, which representation is wirelessly transmitted to the mobile apparatus for display on this apparatus. This is preferably an image file having a resolution which is appropriately reduced, for example, for a PDA display screen so that the representation can be displayed in the appropriate way on the mobile apparatus.

This form of feedback renders the handling of the display system very comfortable for its user. With the aid of the mobile apparatus, he can control, for example, the reproduction of the presentation while viewing the currently displayed image. In addition to the image, data such as, for example, notes for supporting the user can be displayed on the mobile apparatus. Such additional information may be comprised in the presentation but is not displayed by the display apparatus but only transmitted to the mobile apparatus.

In accordance with a further embodiment of the invention, the image display apparatus is connected to a network. This may be a wireless network, on the one hand, in which the network also comprises the wireless connection, according to the invention, between the mobile apparatus and the image display apparatus. Corresponding wireless networks are known to those skilled in the art. Likewise, the image display apparatus may also be cable connected to a network. The cable-connected configuration makes it usually easier to realize a broadband connection for fast transmission of comparatively large quantities of data. Initially, the mobile apparatus preferably does not transmit the presentation data itself, but instructs the image display apparatus to reproduce a presentation whose address is transmitted within the network together with the instruction. The mobile apparatus thus instructs, for example, the reproduction unit of the image display apparatus to request a file in the network and reproduce this file which is indicated by a URL (Uniform Resource Locator).

The file to be, reproduced may be present on the mobile apparatus. The URL transmitted by the apparatus then indicates a resource which is made available by the mobile apparatus in the wireless network. Alternatively, the file to be reproduced may be present on a further apparatus connected to the network. This may be, for example, a server in a local company network. However, when the network connection of the image display apparatus has, for example, access to a wider network such as the Internet, the mobile apparatus can instruct the image reproduction apparatus to reproduce any file, which is addressable by an appropriate URL, on an apparatus connected to the network. This has the advantage that the presentation data, which may take up a considerable size, need not be stored on the mobile apparatus which is usually implemented with relatively few memories. A further advantage is the possible broadband connection of the image display apparatus to a local network, for example, via conventional network cables. In this case, the voluminous presentation data do not need to be transmitted via the wireless network.

In accordance with a further embodiment of the invention, a plurality of presentations may be displayed simultaneously. This is, for example, useful for the simultaneous display of a presentation in two different languages. To this end, the image displayed by the image display apparatus is split up and different presentations are displayed simultaneously in a superposed and/or juxtaposed configuration. On the one hand, a mobile apparatus can then start and/or control a plurality of presentations. However, on the other hand, a plurality of mobile apparatuses may be connected to an image display apparatus and each start and/or control one or more presentations.

These and other aspects of the invention are apparent from and will be elucidated with reference to the embodiments described hereinafter.

In the drawings:

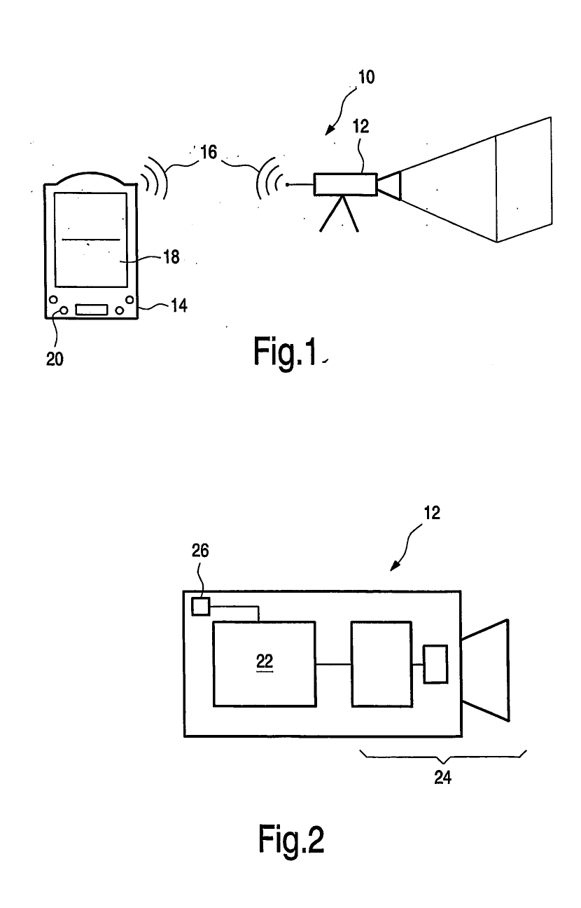

FIG. 1 shows diagrammatically a first embodiment of a display system;

FIG. 2 shows diagrammatically an image display apparatus as shown in FIG. 1;

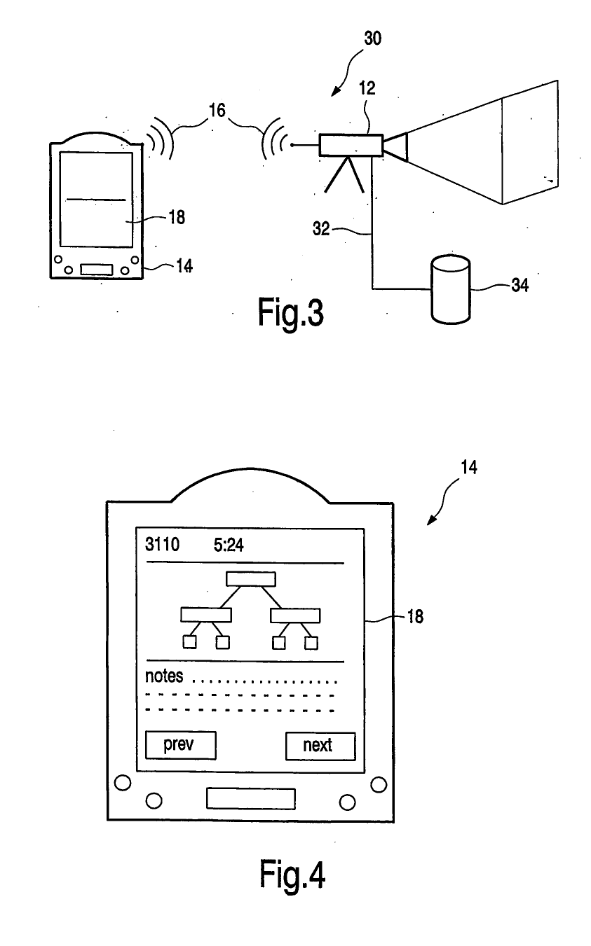

FIG. 3 shows diagrammatically a second embodiment of a display system;

FIG. 4 is a diagrammatic elevational view of a mobile apparatus.

FIG. 1 shows, in a symbolic representation, a first embodiment of a display system 10. The system 10 comprises a projector 12 and a mobile apparatus 14 which are coupled to a wireless network 16.

The mobile apparatus 14 is a PDA, i.e. a portable, for example, handheld minicomputer with a display 18 which is formed as a touch screen, as well as some keys 20.

As is shown symbolically in FIG. 2, the projector 12 has a reproduction unit 22 and a display unit 24. The reproduction unit 22 is connected to a transmitter/receiver 26 for a wireless network, for example, based on the Bluetooth standard. Similarly as a computer, the reproduction unit comprises a central unit on which an operating program is performed. The operating program has, inter alia, the capacity to reproduce files with presentations stored therein, for example, in the PowerPoint format and generate images from these files. The output generated by the reproduction unit 22 is supplied as a VGA signal to the display unit 24, which projects the supplied image.

The reproduction of a presentation on the projector 12 will now be described with reference to FIG. 1. In the first embodiment, the presentation file is stored in the memory of the PDA 14. When a corresponding program of the PDA 14 is called, it first searches in the range of the local radio network 16 for an apparatus to reproduce the presentation. Such a service is made available by the reproduction unit 22 of the projector 12, so that a corresponding feedback to the PDA 14 is given via the wireless network 16.

The PDA 14 now informs the projector 12 of an URL within the network, by which a presentation file should be loaded and reproduced. In the example of FIG. 1, this URL indicates a resource supplied by the PDA 14 within the wireless network 16. The projector 12 has access to the resource via the network 16. The production unit 22 reproduces the presentation file, with the display unit 24 projecting the first image.

Simultaneously, an image file is generated within the projector 12, which image file is a representation of the image projected by the display unit 24. This image file is supplied as a network resource in the network 16. The corresponding program of the PDA 14 calls the supplied image file and shows it on the display 18.

The user controls the presentation process via the PDA 14. Via keys 20 or corresponding areas of the touch screen display 18, the commands “next image” or “previous image” can be given. These commands are transmitted via the wireless network 16 to the reproduction unit 22 of the projector 12.

FIG. 3 also shows symbolically a second embodiment of a display system 30, also with the projector 12 and the PDA 14. In contrast to the first embodiment, the projector 12 now comprises a wired network connection 32. The projector 12 is connected, for example, to a company network via the network connection 32 and is thus connected to all computers connected thereto. Similarly, the network connection 32 can connect the projector 12 to the Internet so that the projector 12 can access any computer connected thereto via the Internet. FIG. 3 shows, for example, only one data memory 34 (for example, file server) in which presentation files are stored which have been released via the network connection 32.

Similarly as in the first embodiment, the PDA 14 transmits a-command to the projector 12 for reproducing a presentation. However, the transmitted URL of the presentation file indicates the data memory 34 in this case. Via the network connection 32, the projector 12 accesses the file which is addressable by the URL and has been supplied by the data memory 34 in the network, and reproduces this file. Here again, the image currently projected by the display unit 24 is supplied in the form of an image file in the wireless network 16. The program run on the PDA 14 calls this image file and shows it on the display 18.

The organization of the wireless network 16 in both embodiments is realized via messages which are sent by the PDA 14, on the one hand, and the projector 12, on the other hand. The wireless network 16 is an ad hoc network, i.e. the corresponding structure is formed automatically as soon as corresponding transmitters and receivers are placed within each other's range. In this case, a plurality of mobile apparatuses and/or a plurality of projectors may be part of the network.

To organize the network and control the reproduction of presentations, the following messages are used:

Search (Projector, RoomID)

The PDA transmits this message to all participants (“broadcast”) so as to inform them that it searches an apparatus of the “projector” type. Optionally, the room number can be indicated as a further search criterion.

Search_Response (UserInterfaceURL)

When an apparatus complies with the search criteria, it replies the requesting PDA by means of this message. As a parameter, the URL is transmitted to the graphic useful surface of the projector.

GetDocument (URL)

Request to the web server specified via the URL to transmit the URL-specified document.

GetDocument_Response(Document)

The web server supplies the required document.

OpenPresentation (PresentationURL)

The PDA informs the projector of the URL of the presentation to be displayed. The projector forms a new presentation window. When presentation windows already exist, the projector adapts the size and position of all windows in such a way that all windows are displayed in a juxtaposed configuration and that the available projection face is optimally utilized.

OpenPresentation_Response (PresentationID)

In reply, the projector supplies an ID number via which the associated presentation window can be identified unambiguously.

NextSlide (PresentationID), PreviousSlide (PresentationID)

The PDA sends this message to the projector so as to change to the next or the previous sheet in the window unambiguously determined by the presentation ID.

OnViewChanged (PresentationID, ViewURL)

The projector informs the PDA that the content of the presentation window unambiguously determined via the presentation ID has changed. The ViewURL is shown on a web page generated by the projector, which the PDA can indicate to its user. This web page shows the instantaneously indicated sheet in a miniature format, as well as possible further information such as, for example, notes, sheet number, elapsed time, etc. The application running on the projector ensures that a new web page with the corresponding information is generated as soon as the user changes to another sheet. The PDA has a built-in web browser function for indicating web pages.

The process for a first scenario, in which a user shows a presentation on a projector, will be described hereinafter.

To this end, the user activates the corresponding application of the PDA which initially searches an appropriate projector by means of the message Search(Projector). The projector 12 replies by means of the reply Search_Response (UserInterfaceURL). By means of OpenPresentation (PresentationURL), the PDA thereupon transmits the URL of a presentation file to be reproduced within the network. The projector 12 assigns an identification to the presentation and transmits it by means of OpenPresentation_Response (PresentationID)).

The reproduction unit 22 reproduces the presentation file and displays the first image of the presentation via the display unit 24. Simultaneously, an image file with a miniature view of the displayed image is generated. Via the network message OnViewChanged (PresentationID, ViewURL), the URL of the graphic file is made known. The application of the PDA calls this graphic file by means of GetDocument (URL), whereupon it is supplied by means of GetDcoument_Response (Document) and is displayed by the PDA on the display 18.

By pressing a key 20 or a corresponding area of the touch screen 18, the user activates a message NextSlide (PresentationID) via which the reproduction unit 22 is instructed to display the next image. A miniature display of this image is also made and its URL is made known via the network 16 (OnViewChanged). In this way, the presentation is reproduced until the end.

In a second scenario, a user may also simultaneously reproduce a plurality of presentations. In contrast to the first scenario described above, two messages OpenPresentation (PresentationURL1) and OpenPresentation (PresentationURL2) are sent one after the other with the two addresses. The projector 12 thereupon partitions the display area and displays the two presentations in a superposed or juxtaposed configuration. Otherwise, the exchange of messages is realized as described above.

In a further scenario, different users each operating a PDA connected to the wireless network 16 simultaneously reproduce a plurality of presentations. This proceeds in a way analogous to that of the second scenario, in which the messages OpenPresentation (PresentationURL1) and OpenPresentation (PresentationURL2) are transmitted by different PDAs in this case.

FIG. 4 shows, by way of example, a display 18 of the PDA 14. In the upper area of the display 18, the information is shown which image (here 3 of 10) is currently displayed. In addition, a clock showing the time elapsed since the start of the presentation or the change of the image is inserted.

In the lower area of the display screen, the image currently displayed by the projector 12 is shown in a miniature form. Below it, associated notes are shown. These notes may be stored in the PDA and may be assigned to the images of the presentation. However, they may also be notes comprised in the displayed presentation file. In this case, these notes together with the miniature graph are arranged on a web page which is generated by the projector 12 and whose URL is made known by means of the message OnViewChanged.

In addition to the above messages, further messages may be used for activating additional functions. For example, it may be desirable to display a plurality of images of a presentation simultaneously in a superposed and/or juxtaposed configuration. This may be useful, for example, when questions on individual images are asked at the end of a lecture, for which purpose the images of the presentation are jointly displayed once more. This function can be realized via a message ChangeNumberOfSlides (PresentationID,n), by which the projector for the relevant presentation is informed how many images are to be displayed simultaneously. The messages NextSlide and PreviousSlide thus cause the projector to show each time the next n images.

Finally, the lower area of the display 18 shows zones used for controlling the presentation process. These zones may be shown as buttons, but it is alternatively possible to represent the zones in the form of a miniature of the previous or next image.

The display on the PDA 14 may vary. For example, it is possible to switch between different modes, in which the image displayed by the projector 12 is relatively large in an image mode and the associated notes are displayed in a smaller form. In a note mode, the notes are shown in a larger form and the image in a smaller form.

1. A system for displaying images, wherein a mobile apparatus (14) is wirelessly connected to an image display apparatus (12),
the mobile apparatus (14) controls a reproduction unit (22) of the image display apparatus (12) in such a way that images are displayed by a display unit (24) of the image display apparatus (12), and
a representation of an image displayed by the display unit (24) is transmitted to the mobile apparatus (14) in which it is displayed by a display unit (18).

2. A system as claimed in claim 1, wherein
the reproduction unit (22) is provided for reproducing data in the form of a presentation comprising a plurality of consecutive images,
the mobile apparatus (14) predetermines the transition from one image to the next.

3. A system as claimed in claim 1, wherein
the image display apparatus (12) is connected to a network (32, 16), and
the mobile apparatus (14) transmits an address of data within the network (32, 16) to the reproduction unit (22),
the reproduction unit (22) reads in the data via the network (16, 32).

4. A system as claimed in claim 3, wherein
the data are stored in the mobile apparatus (14) or in a further apparatus (34) connected to the network.

5. A system as claimed in claim 1, wherein
the reproduction unit (22) is controlled in such a way that the images of a plurality of presentations are simultaneously displayed on top of each other and/or side by side.

6. A system as claimed in claim 1, wherein
the image display apparatus (12) is wire-connected to a network (32).

7. A system as claimed in claim 1, wherein
the mobile apparatus (14) at least comprises the display unit (18), a memory, a central unit and input means (18, 20).

8. A system as claimed in claim 1, wherein
the display unit (24) comprises a device for projecting an image on a projection face.

9. An image display apparatus for use in a system as claimed in claim 1, the apparatus comprising
a reproduction unit (22) for processing presentation data and for generating images therefrom, and
a display unit (24) for displaying the images,
a wireless interface (26) for inputting and outputting data,
wherein the image display apparatus is designed for a representation of an image displayed by the display unit (24) is generated and outputted via the interface (26).

10. A method of displaying images, wherein
a reproduction unit (22) of an image display apparatus (12) is controlled by a mobile apparatus (14) in such a way that images are displayed by a display unit (24) of the image display apparatus (12), and
a representation of an image displayed by the display unit (24) is transmitted from the image display apparatus (12) to the mobile apparatus (14) in which it is displayed by a display unit (18).
